(19) United States
(12) Patent Application Publication
(10) Pub. No.: US 2026/0222205 A1
(43) Pub. Date: Jul. 30, 2026

(54) SECURITY TOKEN IN AN OBJECT IDENTIFIER

(71) Applicant: HEWLETT PACKARD ENTERPRISE DEVELOPMENT LP, Spring, TX (US)

(72) Inventor: Ted Emerson Dunning, San Jose, CA (US)

(21) Appl. No.: 19/037,725

(22) Filed: Jan. 27, 2025

(51) Int. Cl. H04L 9/32

(52) U.S. Cl. CPC H04L 9/3213; H04L 9/3236; H04L 9/3247

(57) ABSTRACT

In some examples, a fabric-connected device receives, from a requester over a fabric, a request for a data object, the request including an object identifier, the object identifier containing a security token and an identifier of the data object. The fabric-connected device validates the security token included in the object identifier, and based on validating the security token, initiates an access operation of the data object.

### BACKGROUND

Electronic devices connected to a communication fabric may be accessible to various different requesters. Such electronic devices connected to the communication fabric can be referred to as fabric-connected devices.

### BRIEF DESCRIPTION OF THE DRAWINGS

Some implementations of the present disclosure are described with respect to the following figures.

FIG. 1 is a block diagram of an arrangement including fabric-connected devices and requesters, according to some examples.

FIG. 2 is a flow diagram of an access controller process according to some examples.

FIG. 3 is a block diagram of a fabric-connected device according to some examples.

FIG. 4 is a block diagram of a storage medium storing machine-readable instructions according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Examples of fabric-connected devices include storage devices (that store data) or other types of devices containing data or functionalities that a requester may seek to access. In some cases, fabric-connected devices rely on the presence of an intermediate access control mechanism between requesters and the fabric-connected devices to prevent unauthorized access to the communication fabric or the fabric-connected devices. However, various interfaces or protocol layers through which client devices perform operations with fabric-connected devices may not implement or support any access control mechanism. In such cases, the data in fabric-connected devices may be subject to unwanted access or modification if the fabric-connected devices do not provide secure access control. Such unwanted access or modification of a fabric-connected device can lead to data corruption or loss, or can lead to other issues at the fabric-connected device. However, configuring the fabric-connected devices to implement access control mechanisms can increase the complexity of the fabric-connected devices, especially if the fabric-connected devices are to support identities across multiple domains (such as domains of different tenants) and if the fabric-connected devices are to interrogate external arbiters of access in such domains. Complex access control mechanisms can also lead to increased product development times of fabric-connected devices and make installation and configuration more difficult and error prone. Integrating complex access control mechanisms can also lead to outages if external identity management systems are configured in an incompatible way.

In accordance with some examples of the present disclosure, a fabric-connected device implements an access control mechanism that relies on a security token included as part of an object identifier of a data object that is to be accessed by a requester, which may be a human, a program, or a machine. Machine-readable instructions (such as firmware or software) in the fabric-connected device can be configured to recognize the security token as part of the object identifier. Note that the object identifier would be provided in requests sent from a requester to the fabric-connected device. Many existing protocols relating to data access do not, however, have any defined way of providing security tokens with requests to fabric-connected devices. In some examples of the present disclosure, a part of a request (more specifically, the object identifier of the request) sent to a fabric-connected device can be modified to incorporate the security token. Including a security token in this way is referred to as tunneling the token through an access path between the requester and the fabric-connected device. The fabric-connected device can validate the security token included in the object identifier, and if the security token is valid, the fabric-connected device can initiate an access operation of the data object sought by the request. The use of security tokens in accordance with some examples of the present disclosure allows for fabric-connected devices to be accessed in a zero trust environment, in which each request of a requester is subject to verification before access is granted.

In some examples of the present disclosure, security tokens can be tunneled through existing protocols so the access control mechanism does not have to rely on modifying protocols relating to access control of devices. Not having to wait for modification, adoption and implementation of new protocols allows for faster introduction of fabric-connected devices. Including a security token in an object identifier of a request means that a new field does not have to be defined in the request to support the inclusion of the security token in the request. Any fabric-connected device that recognizes object identifiers in requests can parse the object identifiers to extract security tokens from the object identifiers. Additionally, an access control mechanism using existing protocols means that product development times can be reduced due to reduced product design times and testing requirements. Moreover, by including security tokens in requests, access control security checks can be performed relatively early in interactions between a requester and a fabric-connected device, such as when the requester is initially establishing a connection with the fabric-connected device.

Although techniques or mechanisms according to some examples of the present disclosure are employed in the context of existing protocols that do not explicitly define the inclusion of security tokens in object identifiers, it is noted that in further examples, techniques or mechanisms consistent with the present disclosure may be used with later developed protocols that explicitly define the inclusion of security tokens in object identifiers.

A “protocol” can refer to a standardized or open-source set of rules and definitions to be followed to perform operations in computing environments, such as accessing data in devices. An “existing protocol” can refer to a protocol defined by a particular standard or open-source specification. A “requester” can refer to an entity that is able to initiate an access of a device. The requester can include a program, a virtual compute entity such as a virtual machine (VM) or a container, or an electronic device.

A “fabric” can refer to a communication medium over which entities can communicate. Examples of fabrics include buses, interconnects, networks, or other communication media. In specific examples, a fabric may include a Peripheral Component Interconnect Express (PCIe) bus, a Compute Express Link (CXL) interconnect, or an Ethernet network. In such examples, the PCIe bus, CXL interconnect, or Ethernet network may be a transport over which messages according to the Nonvolatile Memory Express (NVMe) protocol can be carried. In such examples, requesters can issue NVMe requests to access data in storage devices connected to the PCIe bus, CXL interconnect, or Ethernet network. In other examples, fabrics according to other technologies may be employed, and other types of protocols may be used to send requests for accessing data.

An “access path” between a requester and a fabric-connected device refers to a path (established over a fabric) over which the requester sends requests to the fabric-connected device, and the fabric-connected device sends responses (including data) to the requester.

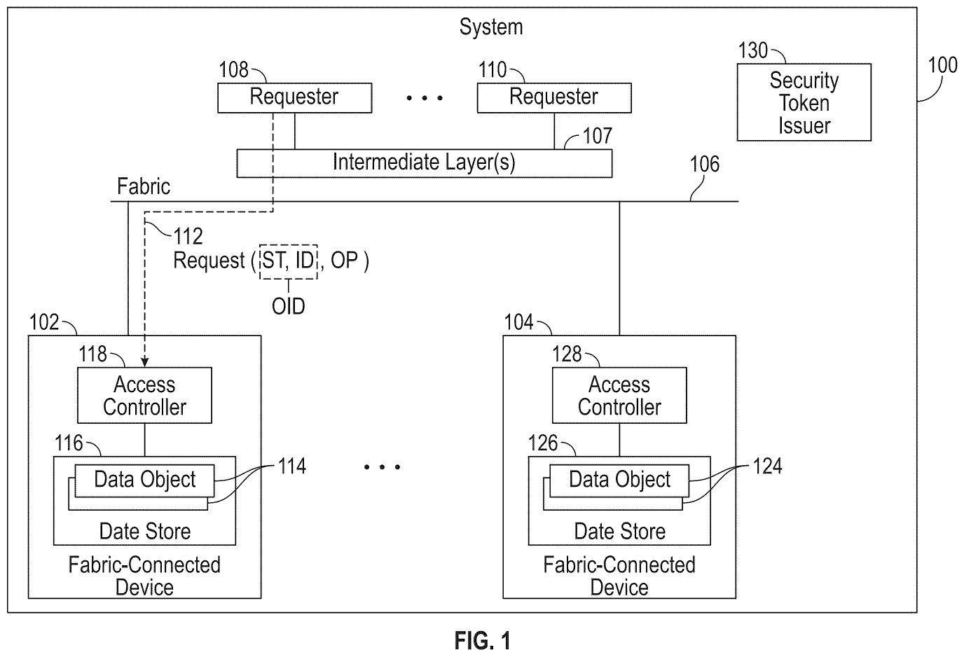

FIG. 1 is a block diagram of a system 100 that includes various fabric-connected devices 102 and 104 connected to a fabric 106. The system 100 can be part of a data center, a cloud computing environment, or any type of computing environment. The fabric-connected devices 102 and 104 may be standalone devices or may be part of one or more server computers or other types of enclosures.

Requesters 108 and 110 can issue requests over the fabric 106 to access data in the fabric-connected devices 102, 104. Although FIG. 1 shows specific quantities of fabric-connected devices and requesters, in other examples, different quantities of fabric-connected devices and requesters may be included in the system 100.

A requester can be coupled to the fabric 106 through one or more intermediate layers 107, including hardware components (e.g., bridge devices, switches, or other types of hardware devices through which information is passed) or software components (e.g., an operating system (OS), a driver, or another software program). In further examples, a requester may be connected directly to the fabric 106.

In the example of FIG. 1, the requester 108 has sent a request 112 over the fabric 106 to the fabric-connected device 102. The request 112 is to access (read or write) a data object 114 stored in a data store 116 of the fabric-connected device 102. In some examples, the fabric-connected device 102 can include a storage device. In such examples, the data store 116 may include a key-value (KV) store, in which keys are used as identifiers to access values (which are examples of the data objects 114). Alternatively, the data store 116 may store other types of data objects 114, such as files of a file-based store (e.g., a file system), tables of a database, or other data objects.

In further examples, the fabric-connected device 102 can be a different type of electronic device that may contain data that is to be accessed by a requester. The fabric-connected device 104 may be the same type of device as the fabric-connected device 102, or alternatively, the fabric-connected devices 102 and 104 may be different types of devices.

In accordance with some examples of the present disclosure, the request 112 includes an object identifier (OID) and operation information OP indicating a type of operation specified by the request. The operation information OP can indicate a read operation or a write operation, for example. As shown in FIG. 1 and Table 1 below, the OID contains two parts: a security token ST and an ID of a target data object that is the subject of the operation specified by the request 112.

TABLE 1
OID

| | |
|---|---|
| Security Token ST | ID |

In some examples, the security token ST is contained in a first subset of bits of the OID. The first subset of bits is made up of a defined quantity of bits. The remainder of the OID contains the ID of the target data object. In other examples, the order of the security token ST and the ID may be flipped, with the ID represented in a first subset of bits of the OID, and the remainder of the OID contains the security token ST.

In examples where the data store 116 is a KV store, the ID includes a data key that identifies a value of the KV store. In such examples, the OID in the request 112 is a key. As illustrated in Table 2 below, the key (OID) in the request 112 includes an operation key (which is an example of a security token) and a data key. The key is thus made up of two parts, one including the security token and the other including the data key that can be used to retrieve a value (a target data object 124) from the KV store.

TABLE 2
Key

| | |
|---|---|
| Operation Key | Data Key |

The key formed by the combination of the operation key and the data key is consistent with the requirements of a protocol (e.g., the NVMe protocol) governing access of data in fabric-connected devices. In such examples, the request 112 is a command specified by the NVMe protocol. The NVMe protocol can specify a maximum length (e.g., 16 bytes or a different maximum length) for the key, in which case the combined length of the operation key and the data key is less than or equal the maximum length. Because an existing field (in this case a key) of an NVMe command is leveraged to include the operation key, the NVMe protocol would not have to be modified to add another field to carry the operation key.

To retrieve a value corresponding to a data key from the KV store, the fabric-connected device 102 can apply a hash function on the data key (or a portion of the data key) to produce a hash value. The hash value is mapped by an index (e.g., a B-tree index or another type of index) to a storage location (in the KV store) that contains the value corresponding to the data key.

In alternative examples, the ID of a target data object 114 can include a pathname (e.g., including a file name and one or more directories of a file system). In other examples, the ID of a target data object 114 can include a uniform resource locator (URL) or any other type of identifier of a data object.

The request 112 is received by an access controller 118 in the fabric-connected device 102. The access controller 118 can parse the OID in the request 112 to extract the security token ST and the ID of the target data object 114. The access controller 118 can validate the security token ST. If the security token ST is successfully validated, the access controller 118 allows the operation indicated by the operation information OP to be performed on the target data object 114 identified by the ID.

The fabric-connected device 104 similarly includes a data store 126 that stores data objects 124 accessible to the requesters 108 and 110. The fabric-connected device 104 also includes an access controller 128 that controls access to the data objects 124 in response to requests (including OIDs and operation information OP) received from the requesters 108 and 110.

In some examples, a security token included in a request sent from a requester to a fabric-connected device can be based on a secret credential associated with the requester. The secret credential can include a password, a certificate, or any other information protected against unauthorized access. In some examples, the secret credential is a time-bounded security credential associated with an expiration time. Once a current time passes the expiration time, the security credential is no longer valid.

An example of a time-bounded security credential includes an X.509 certificate with an expiration time, which is according to the X.509 Public Key Infrastructure (PKI) standard. Other examples of time-bounded security credentials include a temporary security credential generated by an Amazon Web Services (AWS) Security Token Service, a Microsoft Entra ID token, an authorization token stored in the form of a JavaScript Object Notation (JSON) Web Token (JWT) with an expiration time, or any other security credentials.

To create a security token ST, a function F1 is applied on input information including the security credential associated with a requester. In some examples, the function F1 is a hash function that produces a hash value, such as a cryptographic hash function including a Secure Hash Algorithm (SHA) function, a Message Digest 5 (MD5) hash function, or another hash function. The security token ST is based on the hash value.

In alternative examples, the function F1 is an encryption function that encrypts the input information to produce an encrypted value. The security token ST is based on the hash value. In other examples, the function F1 can include a combination of functions. The combination of functions can include a hash function applied on the input information, and an encryption function applied on the hash value produced by the hash function. Alternatively, the combination of functions can include an encryption function applied on the input information, and a hash function applied on the encrypted value produced by the encryption function. In further examples, the function F1 can include other types of functions.

Because the security credential on which the function F1 is applied to produce the security token ST is time-bounded, the security token ST is also time-bounded. If a current time is past the expiration time of the security token ST, then the security token ST is no longer valid.

In addition to the security credential, the input information on which the function F1 is applied may further include other pieces of information, such as any or some combination of the following: a salt, which can be a random number or some other additional information to be combined with the secret credential; a current time; an expiration time of the secret credential; the operation information OP; and a value (e.g., a hash value) derived from the ID (or a portion of the ID) of a target data object that is the subject of a request.

The security token ST for a requester may be generated by a security token issuer 130, which can be a trusted authority. The security token issuer 130 may be implemented with one or more computers. The security token issuer 130 provides generated security tokens ST to respective requesters, which can include the security tokens ST in corresponding requests to access data of fabric-connected devices.

In some examples, the security token ST included in an OID can also be signed using a private key of the security token issuer 130 that generated the security token ST. The private key may be part of a public-private key pair that further includes a public key corresponding to the private key.

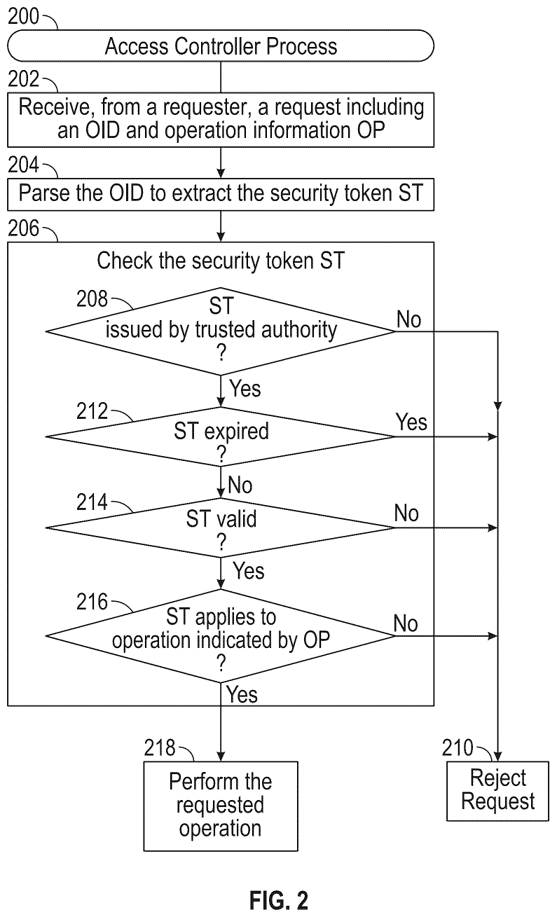

FIG. 2 is a flow diagram of a process 200 performed by an access controller, such as the access controller 118 or 128 in the fabric-connected device 102 or 104. Although FIG. 2 shows a specific order of tasks, in other examples, the tasks may be performed in a different order, some of the tasks may be omitted, and other tasks may be added.

The access controller receives (at 202), from a requester, a request including an OID and operation information OP. The access controller parses (at 204) the OID to extract the security token ST from the OID. For example, if the OID is M bytes in length (where M>1), the security token ST may be contained in a first subset of the M bytes and the ID of the target data object on which an operation indicated by the operation information OP is to be performed may be contained in a second subset of the M bytes. The first subset of the M bytes may be before or after the second subset of M bytes in the OID.

The access controller then checks (at 206) the security token ST. The checking of the security token ST can include a determination (at 208) of whether the security token ST was issued by a trusted authority, such as the security token issuer 130. In some examples, the determination (at 208) can employ a public key algorithm that checks whether the security token ST is signed by the security token issuer 130. The security token issuer 130 may sign the security token ST with a private key of the security token issuer 130. The access controller may decrypt the security token ST using the public key of the security token issuer 130. If the decryption is successful in recovering the security token ST, then the access controller has successfully confirmed that the security token ST was signed by the security token issuer 130 and thus issued by the security token issuer 130. In other examples, other techniques for verifying that the security token ST was issued by a trusted authority can be employed.

Based on determining (at 208) that the security token ST was not issued by the trusted authority, the access controller rejects (at 210) the request. As part of rejecting the request, the access controller can send a response to the requester indicating that the request was not processed (e.g., the response can include an error indication).

However, if the access controller determines (at 208) that the security token ST was issued by the trusted authority, the access controller determines (at 212) whether the security token ST has expired. This determination (at 212) is based on a comparison of a current time to an expiration time of the security token ST. The expiration time can be included in the security token ST. If the current time is later than the expiration time of the security token ST, then the security token ST has expired. As long as the clocks of the entity (the requester or the security token issuer 130) that generated the security token ST and the access controller are generally time synchronized with one another (to within an error tolerance), then the determination of whether the security token ST has expired can be guaranteed to be correct to within the error tolerance. For example, if the entity that generated the security token ST has access to the current time with error δ1, and the access controller has access to the current time with error δ2, then determination of expiration of the security token ST is guaranteed to not occur sooner than δ1+δ2 before the expiration time and no later than δ1+δ2 after the expiration time.

If the security token ST has expired (as determined at 212), then the access controller rejects (at 210) the request. However, if the security token ST has not expired, the access controller determines (at 214) whether the security token ST extracted from the OID of the received request is valid. For example, the access controller can compute a security token to compere to the security token ST extracted from the OID of the received request.

If the function F1 used by the security token issuer 130 in generating the security token ST is a hash function, then the access controller applies the hash function to the same input information (including a security credential and possibly other pieces of information) used by the security token issuer 130 to produce a computed security token. The access controller compares the computed security token to the security token ST extracted from the OID of the received request. If the security tokens match, then the access controller determines (at 214) that the security token ST is valid. If the security tokens do not match, the access controller determines (at 214) that the security token ST is invalid.

In a different example, if the function F1 used by the security token issuer 130 is an encryption function that encrypted the input information using an encryption key to produce the security token ST, then the access controller applies a decryption function that decrypts the security token ST to derive the input information. The access controller then determines (at 214) whether the security token ST is valid based on whether the derived input information is as expected.

If the access controller determines (at 214) that the security token ST is invalid, the request is rejected (at 210). However, if the security token ST is valid, the access controller determines (at 216) whether the security token ST applies to the operation indicated by the operation information OP. In some examples, the security token ST can include information identifying a collection of allowed operations (one or more allowed operations). The information can include a list of allowed operations, where each operation in the list can be identified by a respective operation identifier.

In another example, the information identifying a collection of allowed operations can include a bit mask with bits corresponding to respective operations. If a bit in the bit mask is set to a first state, then the respective operation is allowed. On the other hand, if the bit in the bit mask is set to a different second state, then the respective operation is not allowed. In further examples, the information identifying a collection of allowed operations can further specify targets on which operations are allowed, where targets can include a storage device identified by a device identifier, a logical storage volume identified by a logical unit number (LUN), or any other target.

If the access controller determines (at 216) that the security token ST does not apply to the operation indicated by the operation information OP (e.g., the requested operation is not included in the list of allowed operations or the requested target is not an allowed target), the access controller rejects (at 210) the request. However, if the access controller determines (at 216) that the security token ST applies to the operation indicated by the operation information OP, the access controller proceeds (at 218) to perform the requested operation. Upon completion of the requested operation, the access controller sends a response to the requester. If the requested operation is a read operation, the access controller sends the requested data object to the requester over the fabric 106. If the requested operation is a write operation, the access controller sends an acknowledgement of successful write to the requester over the fabric 106.

As noted above, a protocol may specify a maximum length for the OID in the request. In some examples, security information for validating the requester may not fit entirely in the OID. In such examples, the security token ST constitutes a first portion of the security information. A second portion of the security information may be retrieved by the access controller from a defined storage location in the data store of the fabric-connected device. The access controller combines the first portion of the security information and the second portion of the security information. The requester is validated by validating the combination of the first portion of security information and the second portion of the security information.

In some examples, the fabric-connected devices in the system 100 of FIG. 1 may be part of multiple domains. For example, a first domain can include a first collection of fabric-connected devices, and a second domain can include a second collection of fabric-connected devices that is different from the first collection. The multiple domains may be associated with different tenants of the system 100, for example. A tenant can refer to a group of users, a business unit, or any other entity that has registered to use resources of the system 100. In another example, the multiple domains may be associated with different user accounts.

Security tokens obtained by requesters may be specific to respective domains. The domain-specific security tokens may be issued by respective different security token issuers, for example. A requester may be configured with information identifying a specific security token issuer for a domain that includes a fabric-connected device that the requester wishes to access. The requester can use the configured information to request a security token from the identified security token issuer. In another example, a proxy device may be deployed that can issue requests for security tokens on behalf of requesters. A requester may send a proof of identity such as an Open Authorization (OAUTH) token or a Secure Production Identity Framework for Everyone (SPIFFE) identity to the proxy device, and the proxy device can decide whether to request security token on behalf of the requester.

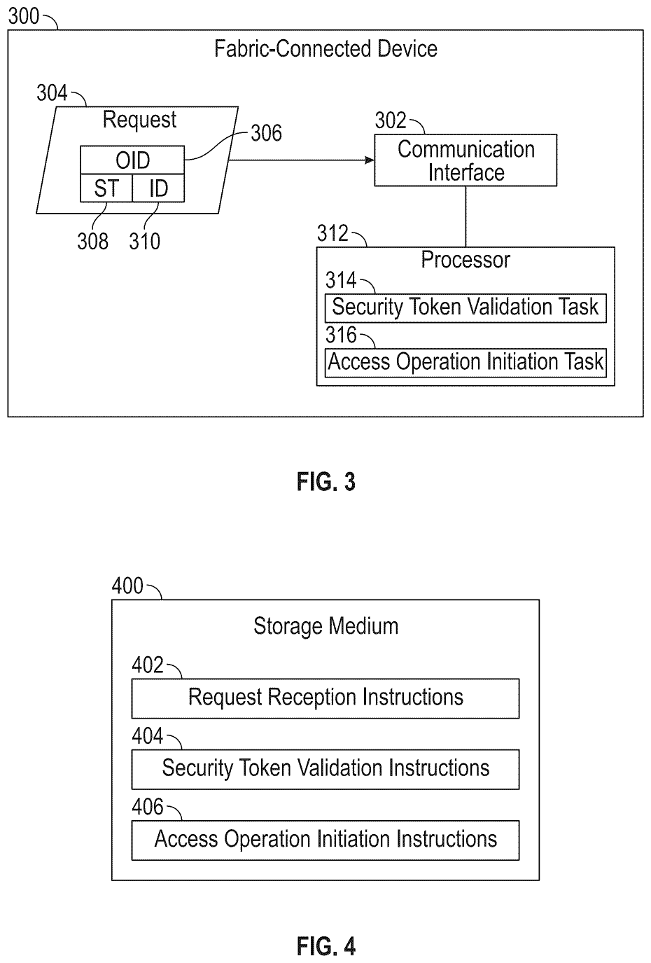

FIG. 3 is a block diagram of a fabric-connected device 300 according to some examples. The fabric-connected device 300 may be an example of the fabric-connected device 102 or 104 of FIG. 1.

The fabric-connected device 300 includes a communication interface 302 to receive, from a requester over a fabric, a request 304 for a data object in a data store, the request 304 including an OID 306 having a security token 308 and an identifier 310 of the data object. Although not shown, the request 304 can also include operation information indicating an access operation (e.g., read or write) to be performed on the data object. The communication interface 302 can include a signal transceiver to transmit and receive signals over a fabric, such as the fabric 106 of FIG. 1. The communication interface 302 can also include one or more protocol layers to manage the communication of information according to one or more protocols.

The fabric-connected device 300 includes a hardware processor 312 to perform various tasks. The hardware processor 312 may be part of the access controller 118 or 128 of FIG. 1, for example. A hardware processor can include a microprocessor, a core of a multi-core microprocessor, a microcontroller, a programmable integrated circuit, a programmable gate array, or another hardware processing circuit. A hardware processor performing a task can refer to a single hardware processor performing the task or multiple hardware processors performing the task.

The tasks of the processor 312 include a security token validation task 314 to validate the security token 308 included in the OID 306. Validating the security token 308 can refer to confirming that the security token 308 is authentic and has not been tampered with. In some examples, the validation of the security token 308 can include one or more of the tasks 208, 212, 214, and 216 of FIG. 2.

The tasks of the processor 312 include an access operation initiation task 316 to, based on validating the security token 308, initiate an access operation of the data object. Initiating the access operation can include the processor 312 sending a command (or multiple commands) to the data store. The access operation can be a read operation or a write operation.

In some examples, the OID 306 includes a key for accessing a KV store, and the key includes the security token 308 and a data key of the data object in the KV store.

In some examples, the OID 306 includes a file pathname for a file-based store, the security token is part of the file pathname, and the identifier of the data object includes a file name included in the file pathname.

In some examples, the security token 308 is generated based on applying a function on information including a secret credential. The function may be a hash function or an encryption function, or a combination of multiple different functions.

In some examples, the information on which the function is applied to generate the security token 308 includes the secret credential and one or more of a salt, a current time, an expiration time of the secret credential, information specifying the access operation, or a value derived from the object identifier.

In some examples, the validating of the security token 308 includes determining that the security token 308 is signed by a trusted authority.

In some examples, the validating of the security token 308 includes determining that the security token 308 has not expired based on an expiration time of the security token 308.

In some examples, the request includes operation information indicating the access operation, and the validating of the security token 308 includes determining that the access operation indicated by the operation information is an allowed operation.

In some examples, the security token 308 includes information identifying a collection of allowed operations, and the determining that the access operation indicated by the operation information is an allowed operation is based on the information in the security token 308.

In some examples, the security token 308 in the object identifier of the request is a first portion of security information, and the processor 312 further retrieves, from a storage location in the fabric-connected device 300, a second portion of the security information. The validation of the security token 308 is based on validating a combination of the first portion of security information and the second portion of the security information.

FIG. 4 is a block diagram of a non-transitory machine-readable or computer-readable storage medium 400 storing machine-readable instructions that upon execution cause a fabric-connected device to perform various tasks.

The machine-readable instructions include request reception instructions 402 to receive, from a requester over a fabric, a request for a data object, the request including an OID that contains a security token and an ID of the data object.

The machine-readable instructions include security token validation instructions 404 to validate the security token included in the OID. The machine-readable instructions can extract the security token from the OID in the received request to perform the validation of the security token.

The machine-readable instructions include access operation initiation instructions 406 to, based on validating the security token, initiate an access operation of the data object.

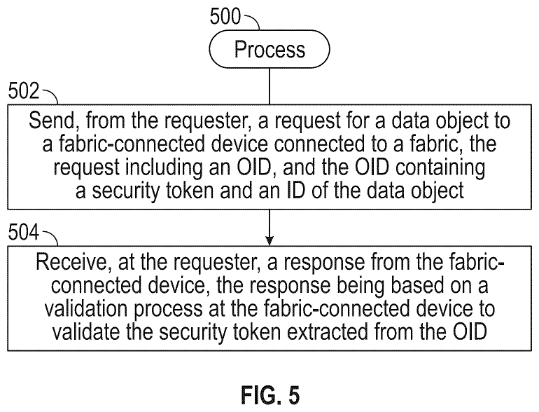

FIG. 5 is a flow diagram of a process 500 according to some examples. The process 500 may be performed by a requester, such as the requesters 108 and 110.

The process 500 includes sending (at 502), from the requester, a request for a data object to a fabric-connected device connected to a fabric, the request including an OID, and the OID containing a security token and an ID of the data object. The sending of the request can include the requester sending the request through one or more intermediate layers (e.g., 107 in FIG. 1) or sending the request directly to the fabric.

The process 500 includes receiving (at 504), at the requester, a response from the fabric-connected device, the response being based on a validation process at the fabric-connected device to validate the security token extracted from the OID. If the validation process successfully validates the security token, the response from the fabric-connected device can include the data object if the requested operation is a read operation, or an acknowledgment of successful write if the requested operation is a write operation. If the validation process fails to validate the security token, the response from the fabric-connected device can include an indication that the requested operation is not performed.

A storage medium (e.g., 400 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM), and a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A fabric-connected device comprising:
a communication interface to receive, from a requester over a fabric, a request for a data object, the request comprising an object identifier, the object identifier comprising a security token and an identifier of the data object; and
a processor to:
validate the security token included in the object identifier, and
based on validating the security token, initiate an access operation of the data object.

2. The fabric-connected device of claim 1, wherein the object identifier comprises a key for accessing a key-value store, and the key comprises the security token and a data key of the data object in the key-value store.

3. The fabric-connected device of claim 1, wherein the object identifier comprises a file pathname for a file-based store, the security token is part of the file pathname, and the identifier of the data object comprises a file name included in the file pathname.

4. The fabric-connected device of claim 1, wherein the security token is generated based on applying a function on information comprising a secret credential.

5. The fabric-connected device of claim 4, wherein the function includes a hash function.

6. The fabric-connected device of claim 4, wherein the function includes an encryption function.

7. The fabric-connected device of claim 4, wherein the security token is generated based on applying the function on the information comprising the secret credential and one or more of a salt, a current time, an expiration time of the secret credential, information specifying the access operation, or a value derived from the object identifier.

8. The fabric-connected device of claim 1, wherein the validating of the security token comprises determining that the security token is signed by a trusted authority.

9. The fabric-connected device of claim 1, wherein the validating of the security token comprises determining that the security token has not expired based on an expiration time of the security token.

10. The fabric-connected device of claim 1, wherein the request comprises operation information indicating the access operation, and the validating of the security token comprises determining that the access operation indicated by the operation information is an allowed operation.

11. The fabric-connected device of claim 10, wherein the security token comprises information identifying a collection of allowed operations, and wherein the determining that the access operation indicated by the operation information is an allowed operation is based on the information in the security token.

12. The fabric-connected device of claim 1, wherein the security token in the object identifier of the request is a first portion of security information, and the processor is to further:
retrieve, from a storage location in the fabric-connected device, a second portion of the security information, and
validate the security token by validating a combination of the first portion of security information and the second portion of the security information.

13. A method comprising:
sending, from a requester in a system comprising a hardware processor, a request for a data object to a fabric-connected device connected to a fabric, the request comprising an object identifier, the object identifier comprising a security token and an identifier of the data object; and
receiving, at the requester, a response from the fabric-connected device, the response based on a validation process at the fabric-connected device to validate the security token extracted from the object identifier.

14. The method of claim 13, further comprising:
obtaining, by the requester, the security token from a trusted authority.

15. The method of claim 14, wherein the trusted authority is part of a first domain different from a second domain, the fabric-connected device is part of the first domain, and the security token obtained from the trusted authority is for the first domain.

16. The method of claim 13, wherein the security token is a time-bounded security token associated with an expiration time.

17. The method of claim 13, wherein the object identifier comprises a key for accessing a key-value store, and the key comprises the security token and a data key of the data object in the key-value store.

18. The method of claim 13, wherein the object identifier comprises a file pathname for a file-based store, the security token is part of the file pathname, and the identifier of the data object comprises a file name included in the file pathname.

19. A non-transitory machine-readable storage medium comprising instructions that upon execution cause a fabric-connected device to:
receive, from a requester over a fabric, a request for a data object, the request comprising an object identifier, the object identifier comprising a security token and an identifier of the data object;
validate the security token included in the object identifier; and
based on validating the security token, initiate an access operation of the data object.

20. The non-transitory machine-readable storage medium of claim 19, wherein the validating of the security token comprises determining that the security token has not expired based on an expiration time of the security token, and the security token was issued by a trusted authority.
